(19) United States
(12) Patent Application Publication
(10) Pub. No.: US 2025/0315582 A1
(43) Pub. Date: Oct. 9, 2025

(54) METHOD AND APPARATUS FOR AUTOMATIC DESIGN CONSTRAINT GENERATION FOR CHIP IP USING GENERATIVE ARTIFICIAL INTELLIGENCE

(71) Applicant: Marvell Asia Pte Ltd, Singapore (SG)

(72) Inventors: Jeanne Trinko Mechler, Colchester, VT (US); Patricia Chong Fong, Cupertino, CA (US)

(21) Appl. No.: 19/041,100

(22) Filed: Jan. 30, 2025

Related U.S. Application Data
(60) Provisional application No. 63/575,600, filed on Apr. 5, 2024.

(51) Int. Cl. G06F 30/3315; G06F 111/04; G06F 119/02; G06F 119/12

(52) U.S. Cl. CPC G06F 30/3315; G06F 2111/04; G06F 2119/02; G06F 2119/12

(57) ABSTRACT

A new approach is disclosed to support automatic design constraint generation for chip IP using generative artificial intelligence (AI). A document ingress module accepts a plurality of inputs from multiple design documentation sources describing a chip IP. An LLM training module trains the one or more LLMs with targeted training materials on embodiments of the specific chip IP. A generative AI module automatically generates a set of design constraints for the chip IP using the one or more trained LLMs based on the plurality of inputs from multiple design documentation sources. Once the set of design constraints have been generated, a document egress module is configured to verify accuracy of the set of design constraints by converting the set of design constraints into a format of a human language document that includes attributes specific to design configuration of the chip IP.

### RELATED APPLICATION

This application is a nonprovisional application and claims the benefit and priority to a provisional application No. 63/575,600 that was filed on Apr. 5, 2024, which is incorporated herein by reference in its entirety.

### BACKGROUND

Comprehensive chip intellectual property (IP) such as chip interface IP often need to support multiple standards, such as Ethernet and PCIe, and includes test functionalities. Very large scale integrated (VLSI) chips can have hundreds of lanes of serializer deserializer (SerDes) together with their digital controller IP (for example PCIe Gen5 or Ethernet) and other chip interface IPs developed by multiple vendors. Databooks describing these SerDes typically exceed 200 pages and include many configuration options, such as pulse amplitude modulation 4-level (PAM4) and/or non-return-to-zero (NRZ), bus-data width, PCIe generation, etc., all affecting the frequency at which the SerDes operate. One of many challenging aspects of integrating many different interfaces into a chip design is to create design constraints, which can be but is not limited to, Synopsys Design Constraints (SDC), which are timing commands that define the performance and configuration for the chip interface IP in a specific chip design. These design constraints defining timing, area, and power constraints for the chip design are often used multiple times during the chip design process, such as during design, synthesis, and all other aspects of physical implementation of the chip.

Most chips have multiple kinds of interface IP, such as DDR memory physical interfaces (PHY), die-to-die interfaces, multiple SerDes standards, as well as USB PHYS, high bandwidth memory (HBM) PHYs, and their digital controllers. These interface IP blocks (SerDes and their digital controller IP for specific standards such as PCIe Gen 5 or Ethernet) have their own design specifications, databooks, or user guides containing numerous timing parameters per configuration and require accurate design constraints for all steps in the design process. The information needed to code the design constraints accurately is often distributed in multiple sections of a document or even across multiple documents. For example, timing information can exist in documentation by function, by mode (such as system function mode or manufacturing test mode), in tables of pin descriptions, or in a dedicated timing section. The various documentations contain information such as frequency in various modes, which must be converted into time in picoseconds or nanoseconds with appropriate clock uncertainty, required transition times, and other special tests such as skew checks that go beyond traditional checking of a timing tool. Design constraints for a chip comprise many thousands of lines of code and are currently manually coded by a VLSI chip designer based on their reading of the databook and/or examples. Any incorrect or lack of design constraints would lead to improperly timed paths that can result in non-functional silicon and/or an impact costing millions of dollars due to scrapped or non-conforming silicon. As a result, design constraints often need to undergo multiple revisions and reviews during the design process. Industry wide, 15% of chips that must be taped out again due to non-conforming silicon, require design corrections due to timing errors. In addition, with chiplet-based architectures on multi-die packages, the quantity of design constraints is multiplied and the ability to ensure accuracy becomes even more complex. The current techniques of manual review of design constraints or constraint syntax checkers that have no knowledge of specific IP are no longer sufficient.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a diagram of system supporting automatic chip design constraint generation using generative AI according to one aspect of the present embodiments.

FIG. 2A depicts an example of a generic set of SDC Tel for clock creation using an untrained LLM in a question and response format according to one aspect of the present embodiments. FIG. 2B depicts an example of a Table of Content of a specific IP documentation that is used to train the LLM for generating chip-specific design constraints for clock creation according to one aspect of the present embodiments. FIG. 2C depicts an example of a set of design constraints for clock creation generated using the LLM trained by the specific IP documentation of FIG. 2B according to one aspect of the present embodiments.

FIG. 3A depicts an example of an excerpt from a specification that is used to train the LLMs for generating chip-specific design constraints according to one aspect of the present embodiments. FIG. 3B depicts an example of a response on a frequency generated using the LLM trained by the specification of FIG. 3A according to one aspect of the present embodiments. FIG. 3C depicts another example of a response on a frequency generated by using the LLM trained by the specification of FIG. 3A for design review according to one aspect of the present embodiments. FIG. 3D depicts an example of a response on a period in nanosecond generated using the LLM trained by the specification of FIG. 3A for design review according to one aspect of the present embodiments. FIG. 3E depicts an example of a response on a period in picosecond generated using the LLM trained by the specification of FIG. 3A for design review according to one aspect of the present embodiments.

FIG. 4A depicts an example of an excerpt from a specification for PIPE_PCLK0, PIPE_SCLK_OUT0, and PIPE_TXCLK_OUT0 that is used to train the LLMs for generating chip-specific design constraints for PIPE parallel interface data clock according to one aspect of the present embodiments. FIG. 4B depicts an example of a frequency of PIPE_SCLK_OUT0 generated using the LLMs trained by the unclear specification of FIG. 4A. FIG. 4C depicts an example of a frequency of PIPE_TXCLK_OUT0 generated using the LLMs trained by the unclear specification of FIG. 4A.

FIG. 5A depicts an example of an excerpt from an improved specification for PIPE_PCLK0, PIPE_SCLK_OUT0, and PIPE_TXCLK_OUT0 that is used to train the LLMs for generating chip-specific design constraints for PIPE parallel interface data clock according to one aspect of the present embodiments. FIG. 5B depicts an example of a frequency of PIPE_TXCLK_OUT0 generated using the LLMs trained by the improved specification of FIG. 5A according to one aspect of the present embodiments. FIG. 5C depicts an example of the maximum period of PIPE_TXCLK_OUT0 generated by using the LLMs trained by the improved specification of FIG. 5A according to one aspect of the present embodiments.

FIG. 6 depicts an example of an automatically-generated design constraint template in SDC tel according to one aspect of the present embodiments.

FIG. 7 depicts an example of a human language text documentation containing known information about a clock named HSS_CMO_CLK_RATE_1_O in an organized format generated from a well commented thorough SDC according to one aspect of the present embodiments.

FIG. 8 depicts a flowchart 800 of an example of a process to support automatic chip design constraint generation using generative AI according to one aspect of the present embodiments.

FIG. 9 is a block diagram illustrating an example of a computing system/device used to implement the system of FIG. 1 to support automatic chip design constraint generation using generative AI according to one aspect of the present embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

A new approach is disclosed that contemplates system and method to support automatic design constraint generation for chip IP using generative artificial intelligence (AI). As referred to hereinafter, the phrase generative AI refers to one or more large language models (LLMs) coded in a programming language, which can be but is not limited to a design constraint language such as SDC Tel. First, a document ingress module is configured to accept a plurality of inputs from multiple design documentation sources describing a chip IP. An LLM training module is configured to train the one or more LLMs with targeted training materials on embodiments of the specific chip IP. The generative AI module is then configured to automatically generate a set of design constraints for the chip IP using the one or more trained LLMs based on the plurality of inputs from multiple design documentation sources describing the chip IP. In some embodiments, the generative AI module is also configured to automatically generate a design constraint template specific to the set of design constraints of the chip IP. Once the set of design constraints have been generated, a document egress module is configured to verify accuracy of the set of design constraints by converting the set of design constraints into a format of a human language document, e.g., a human language text documentation that includes attributes specific to design configuration of the chip IP. Such documentation can be used for design review of a chip design and/or improvement to the documentation.

The disclosed approach enables automatic, rapid and accurate generation of design constraints for the chip IP, resulting in first-time correct/functional silicon implementation of the chip IP. As such, the disclosed approach reduces design development cycle time and avoids costly design corrections for the chip IP. Furthermore, the disclosed approach is portable across multiple types of chip IPs in all technology nodes of chip implementation. Additionally, the disclosed approach improves documentation of the chip IP, leading to easier integration of the chip IP into chip designs.

Although chip interface IP is used as a non-limiting example of the chip IP in the discussions hereinafter, the same or similar approach is equally applicable to other types of chip IP including but not limited to IPs on analog to digital conversion blocks, timing s, etc. as understood by one ordinarily skilled in the art.

Although static timing constraints are used as non-limiting examples of chip design constraints in the discussions hereinafter, the same or similar approach is equally applicable to other types of chip design constraints including but not limited to power, area, noise, etc.

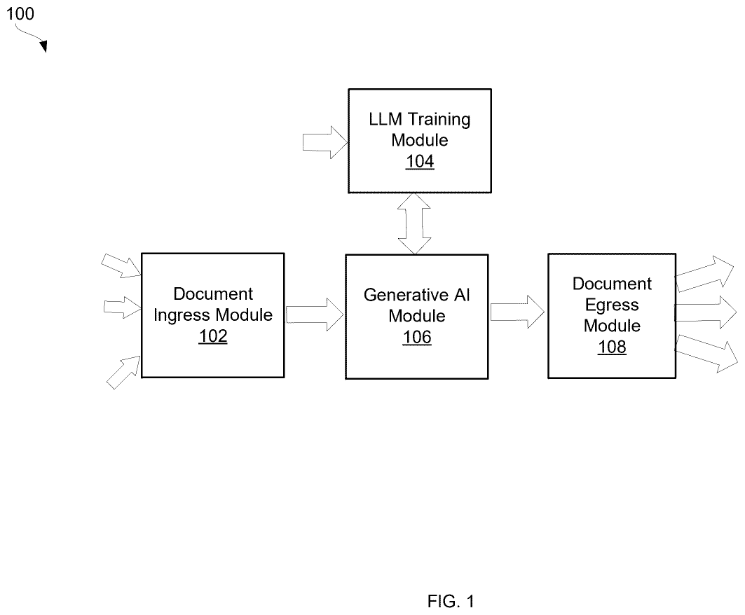

FIG. 1 depicts an example of a diagram of a system 100 supporting automatic chip design constraint generation using generative AI. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

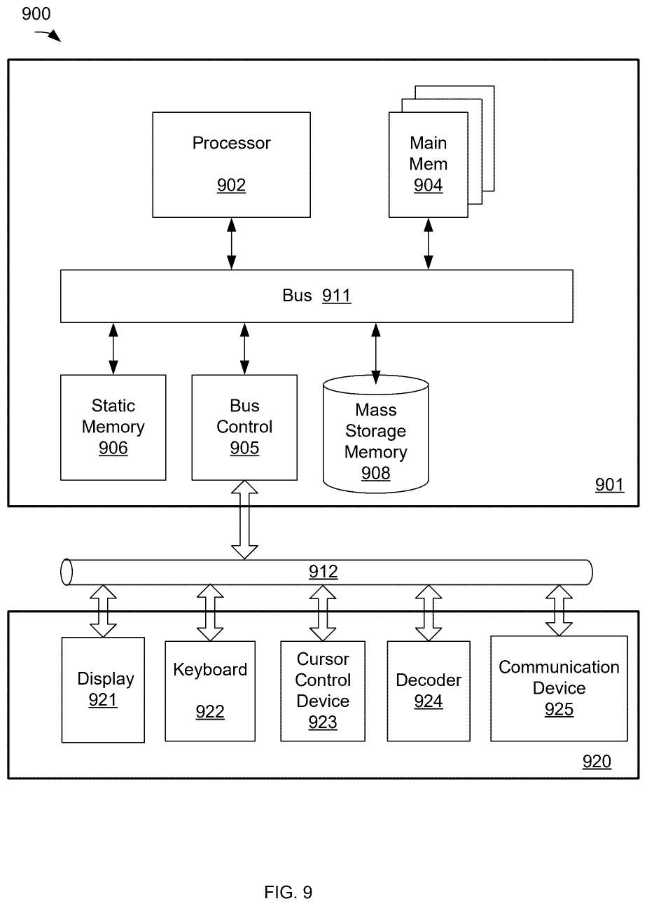

In the example of FIG. 1, the system 100 includes one or more of a document ingress module 102, an LLM training module 104, a generative AI module 106, and a document egress module 108. It is appreciated that each of the modules of the system 100 may run on one or more computing units or devices (as shown by the non-limiting example of FIG. 9) each with software instructions stored in a storage unit such as a non-volatile memory of the computing unit for practicing one or more processes. When the software instructions are executed, at least a subset of the software instructions is loaded into memory by one of the computing units, which becomes a special purposed one for practicing the processes. The processes may also be at least partially embodied in the computing units into which computer program code is loaded and/or executed, such that, the computing units become special purpose computing units for practicing the processes.

In the example of FIG. 1, the document ingress module 102 is configured to accept a plurality of inputs from multiple design documentation sources describing a specified portion of a chip or a specified chip IP block such as a chip interface IP. Here, the plurality of inputs may span numerous documents in written human language paragraphs, data tables, and programming language such as SDC Tcl. In some embodiments, the first input to the data ingress module 102 is a human language documentation written by developers of the chip IP, wherein the human language documentation can be but is not limited to a user guide, a design specification, a databook, etc. In some embodiments, the human language documentation does not have a thorough timing section that contains all the timing information an engineer would need in order to write a complete set of design constraints that correctly reflected the chip design's timing requirements. Such timing information may be distributed through other sections of the human language documentation such as sections on clocking, usage, or mode. In some embodiments, the timing information may also be embedded in other detailed documentation of the chip interface IP and would requires the engineer to read an excessive amount of documentation to find additional information for the timing to be accurate.

In some embodiments, the second input to the document ingress module 102 is an optional design constraint template of the chip IP, if available, from the IP developers. Occasionally, the design constraint template is provided with the chip interface IP for the engineer to have a basis to start writing the design constraints. Note that the chip interface IP may have thousands of functional clock pins classified by input, output, analog, clock, scan-related, etc. The purpose of the design constraint template is to list all the functional clock pins with generic parameters. Since the chip interface IP may have a wide range of usages and is human written, the design constraint template may have contents that are inconsistent from one IP to another, and therefore, can be error prone, lack of important details, or have an excess of information for all usages of the chip interface IP. Furthermore, the design constraint template needs to be accurately configured/customized for each chip design by the engineer with frequency and design details incorporated, and with details and usages for pins and clocks included that may not be used for a specific application.

In some embodiments, the third input to the document ingress module 102 is design information of the chip interface IP, ranging from technology sign-off derates and margins, which accommodate yield and lifetime, to usage of the chip interface IP for a specific chip design, wherein the design information includes one or more of settings of registers, usage, frequencies of clocks, and environment information, such as process, voltage, and temperature.

In some embodiments, the document ingress module 102 is configured to verify consistencies among the plurality of inputs describing various specifications, features, and requirements of the chip interface IP and to correct any inconsistencies or errors in the plurality of inputs regarding the chip interface IP. In some embodiments, the document ingress module 102 is configured to consolidate and integrate the plurality of inputs into one unified documentation before providing such unified documentation to the generative AI module 106.

In the example of FIG. 1, the LLM training module 104 is configured to train one or more LLMs with training materials targeted for a specified portion of a chip or a specified chip IP block such as a specific chip interface IP, e.g., feature or functionality. In some embodiments, the targeted training material can be but is not limited to design specification for the specific chip interface IP. In some embodiments, the targeted training material can be user/designer specification regarding the specific chip interface IP. As such, the LLM training module 104 is configured to train the one or more LLMs towards generating different sets of design constraints targeting different chip interface IPs by utilizing different kinds of training materials. In some embodiments, the targeted training material used by the LLM training module 104 may include the same or similar type and/or content of certain design documentations imported into the document ingress module 102. In some embodiments, the LLM training module 104 is configured to train the one or more LLMs ahead of the time and/or continuously in real time when the one or more LLMs are utilized by the generative AI module 106 to generate a set of design constraints as discussed below.

In the example of FIG. 1, the generative AI module 106 is configured to automatically generate a set of design constraints for the specified portion of a chip or a specified chip IP block such as the chip interface IP using the one or more trained LLMs based on the plurality of inputs describing the chip interface IP. In some embodiments, the generative AI module 106 is configured to generate the set of design constraints on chip timing based on the human language documentation pertaining to timing, information from the design constraint template, and the design information of the chip interface IP (e.g., signoff criteria, configurations, etc.). For a non-limiting example, a design constraint on clock, e.g., create_clock, creates a clock by translating clocking frequencies to periods. For another non-limiting example, a design constraint on clock attributes/uncertainties, e.g., set_clock_uncertainty, translates variations in the clock to uncertainties on the clock signal. For another non-limiting example, design constraints can infer clock relationships via, e.g., set_clock_group, set_data_check. For another non-limiting example, design constraints can create signal exceptions (e.g., set_multicycle_path, set_false_path) based on register settings, or create skew checks between signals. If the set of design constraints for the chip interface IP is incomplete or incorrect, then the plurality of inputs describing the chip interface IP are incomplete or incorrect, and need to be enhanced.

In some embodiments, one of the trained LLMs is a retrieval augmented generative (RAG) system, which retrieves the most relevant documents for a user's query/question, augments/combines the user's query with the relevant documents, and generates a response based on augmented query. In some embodiments, the generative AI module 106 is configured to utilize the trained RAG system in conjunction with the rest of the one or more trained LLMs to generate the set of design constraints. In some embodiments, the RAG system is trained with one or more of the targeted IP documents, SerDes design configuration examples and their matching design constraint syntax. The generative AI module 106 then utilizes the trained RAG system to correctly generate the set of design constraints for the chip by integrating a specific set of SerDes IP or other IPs.

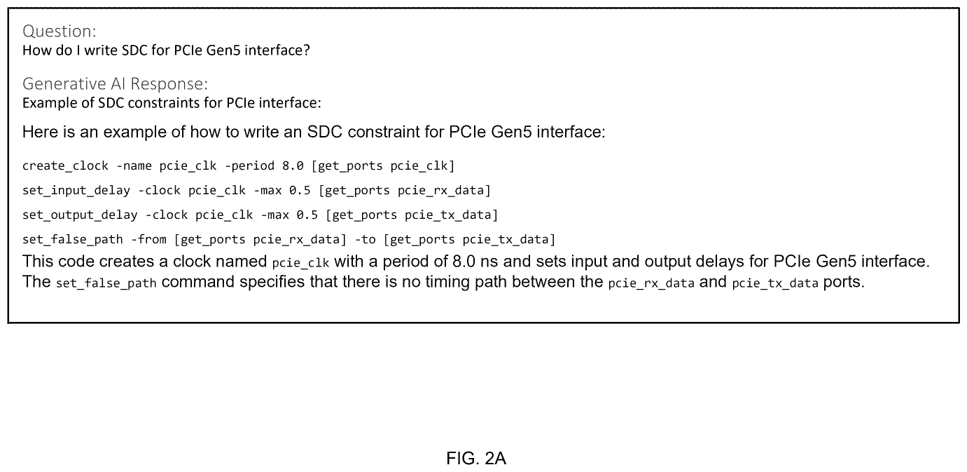

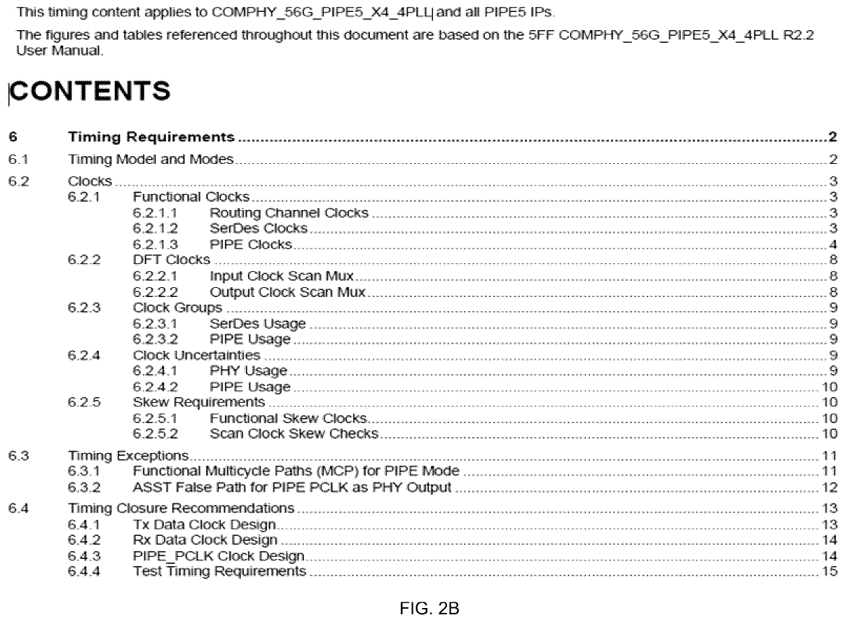

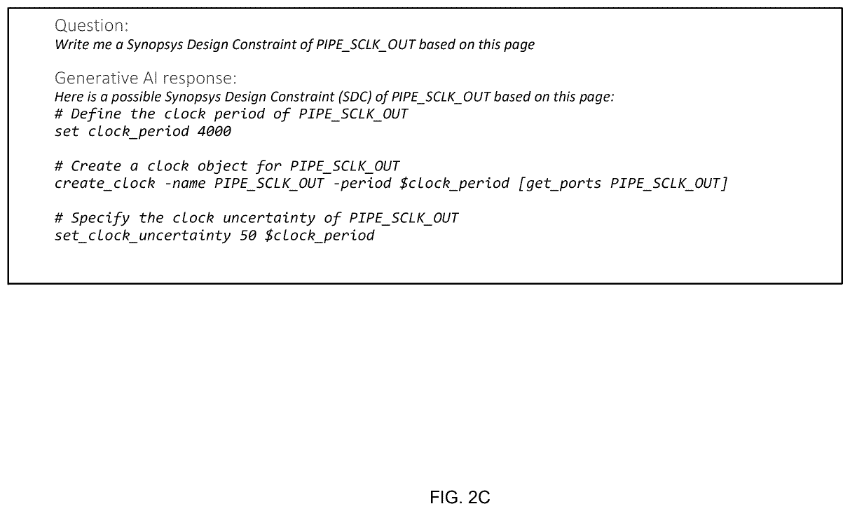

FIG. 2A depicts an example of a generic set of SDC Tel for clock creation generated by the generative AI module 106 using an untrained LLM in a question and response format. Since the LLM is not target-trained for any specific chip design IP, the set of design constraints is a set of generic SDC Tel code that is not specific to a chip design or a chip IP. FIG. 2B depicts an example of a Table of Content of a specific IP documentation (e.g., COMPHY_56G_PIPE5_X4_4PLL timing requirements specification) that is used to train the LLM for generating chip IP-specific design constraints for clock creation. FIG. 2C depicts an example of a set of design constraints for clock creation generated by the generative AI module 106 using the LLM trained by the specific IP documentation of FIG. 2B. As shown by the example of FIG. 2C, the generative AI module 106 generates a set of design constraints specifically for PIPE_SCLK_OUT in SDC Tel code.

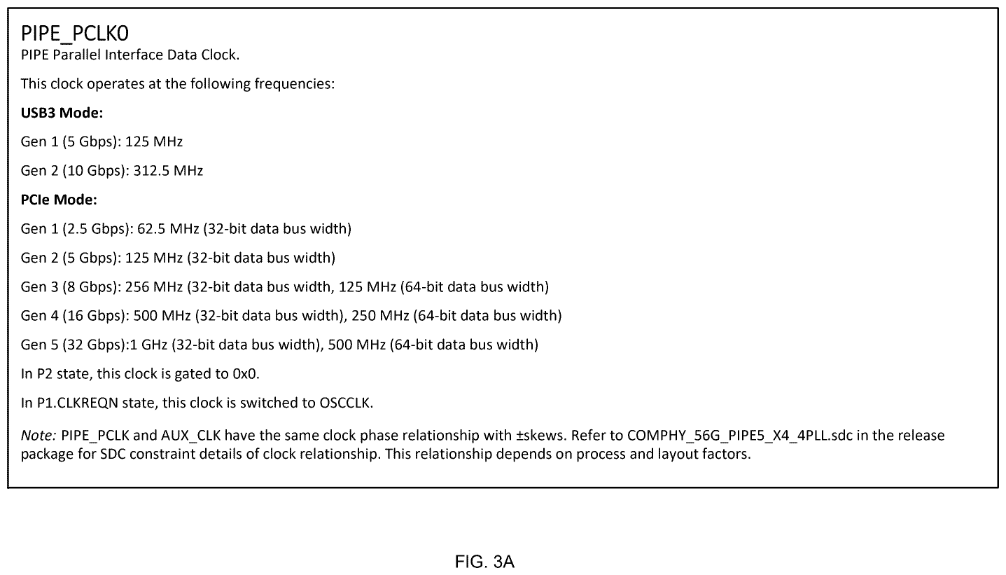

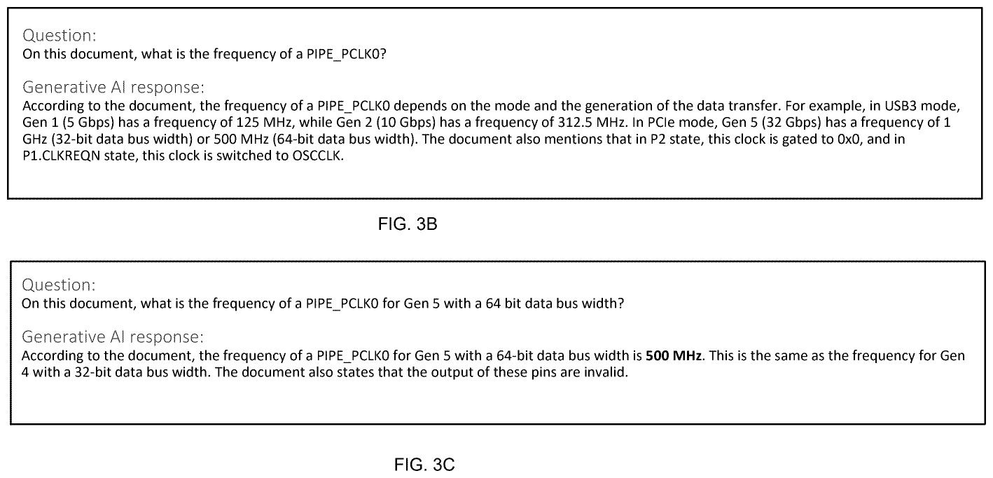

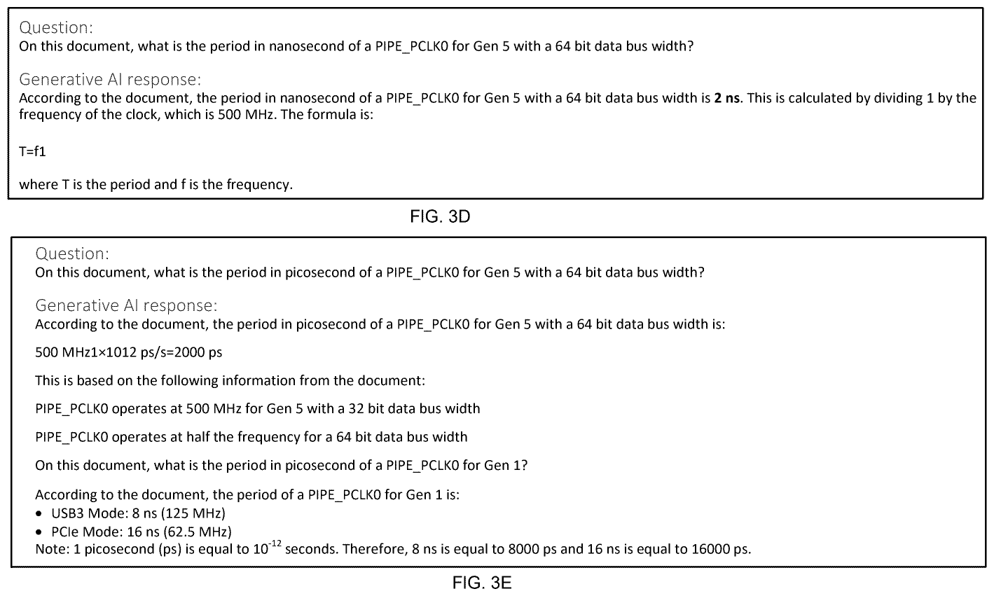

FIG. 3A depicts an example of an excerpt from a PIPE_PCLKO specification that is used by the LLM training module 104 to train the LLMs for generating chip-specific design constraints for PIPE parallel interface data clock. FIG. 3B depicts an example of a response on a frequency of PIPE_PCLKO generated by the generative AI module 106 using the LLM trained by the PIPE_PCLKO specification of FIG. 3A, wherein the generated response can be used for design review of PIPE_PCLKO. FIG. 3C depicts another example of a response on a frequency of PIPE_PCLKO generated by the generative AI module 106 using the LLM trained by the PIPE_PCLK0 specification of FIG. 3A for design review, wherein PIPE_PCLK0 is further constrained to a specific configuration of Gen 5 with a 64 bit data bus width. FIG. 3D depicts an example of a response on a period in nanosecond of PIPE_PCLK0 generated by the generative AI module 106 using the LLM trained by the PIPE_PCLK0 specification of FIG. 3A for design review, wherein PIPE_PCLK0 is also constrained to the specific configuration of Gen 5 with a 64 bit data bus width. FIG. 3E depicts an example of a response on a period in picosecond of PIPE_PCLK0 generated by the generative AI module 106 using the LLM trained by the PIPE_PCLK0 specification of FIG. 3A for design review, wherein PIPE_PCLK0 is constrained to the specific configuration of Gen 5 and Gen 1 with a 64 bit data bus width, respectively.

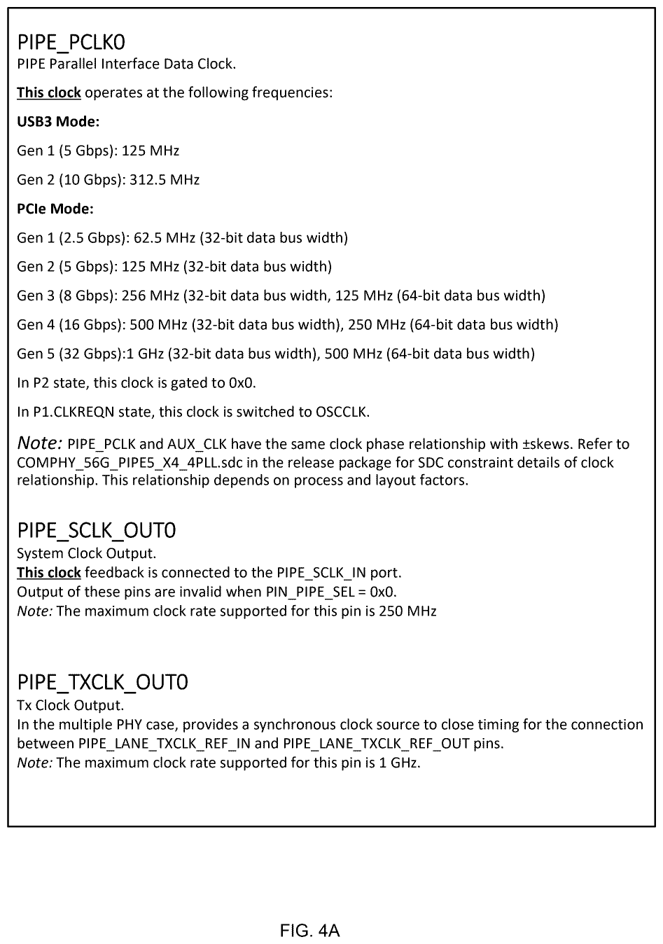

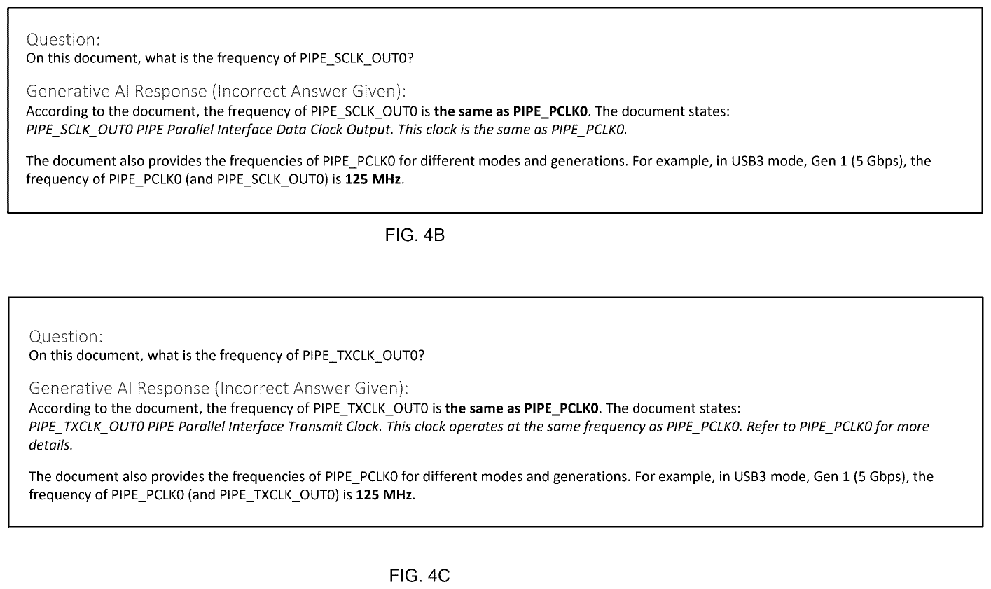

In some embodiments, the type and/or content of the targeted training material utilized by the LLM training module 104 to train the one or more LLMs may affect the set of design constraints the generative AI module 106 is able to generate or infer from the one or more so-trained LLMs. In some cases, the generative AI module 106 may be unable to infer the correct set of design constraints if the training material is vague, incomplete, or inconsistent, or can be misunderstood by humans. FIG. 4A depicts an example of an excerpt from a specification for PIPE_PCLK0, PIPE_SCLK_OUT0, and PIPE_TXCLK_OUT0 that is used to train the LLMs for generating chip-specific design constraints for PIPE parallel interface data clock. The document shown in FIG. 4A explicitly states that PIPE_SCLK_OUT0 maximum clock rate is 250 MHz and PIPE_TXCLK_OUT0 maximum clock rate is 1 GHz. As shown in FIG. 4A, the PIPE_PCLK0 is referred as “This clock”, which may be misinterpreted by the generative AI module 106 using the LLMs trained by the documentation. FIG. 4B depicts an example of a frequency of PIPE_SCLK_OUT0 generated by the generative AI module 106 using the LLMs trained by the unclear specification of FIG. 4A, which misinterpreted PIPE_SCLK_OUT0 to be the same as PIPE_PCLK0. FIG. 4C depicts an example of a frequency of PIPE_TXCLK_OUT0 generated by the generative AI module 106 using the LLMs trained by the unclear specification of FIG. 4A, which misinterprets PIPE_TXCLK_OUT0 to be the same as PIPE_PCLK0.

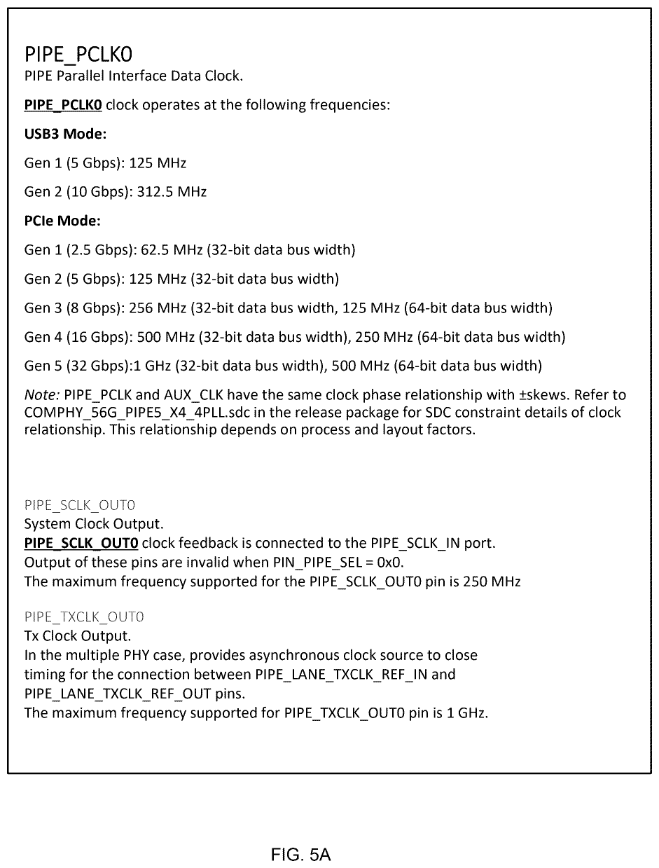

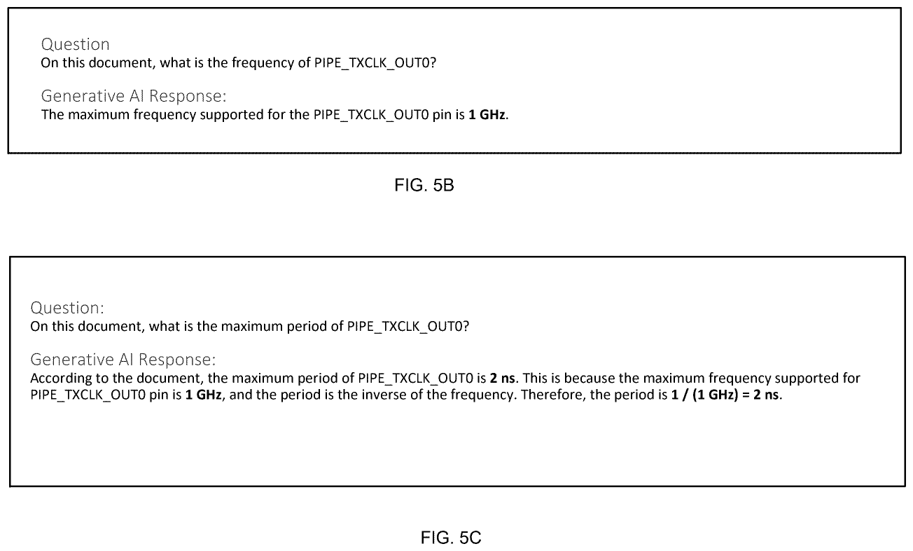

In some embodiments, the LLM training module 104 is configured to train the one or more LLMs using improved/corrected documentation in order for the generative AI module 106 is able to infer and generate a correct set of design constraints from the one or more trained LLMs. FIG. 5A depicts an example of an excerpt from an improved specification for PIPE_PCLK0, PIPE_SCLK_OUT0, and PIPE_TXCLK_OUT0 that is used to train the LLMs for generating chip-specific design constraints for PIPE parallel interface data clock. The improved specification of FIG. 5A corrects vague wordings in the excerpt of FIG. 4A with explicitly names clocks and frequencies to avoid incorrect SDC Tcl coding of the design constraints. FIG. 5B depicts an example of a frequency of PIPE_TXCLK_OUT0 generated by the generative AI module 106 using the LLMs trained by the improved specification of FIG. 5A, which correctly sets PIPE_TXCLK_OUT0 at 1 GHz. FIG. 5C depicts an example of the maximum period of PIPE_TXCLK_OUT0generated by the generative AI module 106 using the LLMs trained by the improved specification of FIG. 5A, which correctly sets the maximum period at 2 ns.

In some embodiments, the design constraint template can be utilized to improve the documentation for the specific chip interface IP so that the generative AI module 106 can understand the improved documentation and to generate a set of correct design constraints. For example, a human-generated design constraint template for a combination 4-port SerDes that supports both Ethernet and PCI Express mode involves multiple configurations of the SerDes, leading to hundreds of lanes to be time constrained. Such human-generated design constraint template, however, is error-prone and may not have been configured for the mode usage, such as ethernet or PCIe. Furthermore, the design constraint template may not have design details incorporated, and usages for pins and clocks that are included may not be used for a specific chip IP. As such, the design constraint template needs to be accurately customized/modified for each chip interface IP in order to be used by the generative AI module 106 to generate an accurate set of design constraints for the chip interface IP.

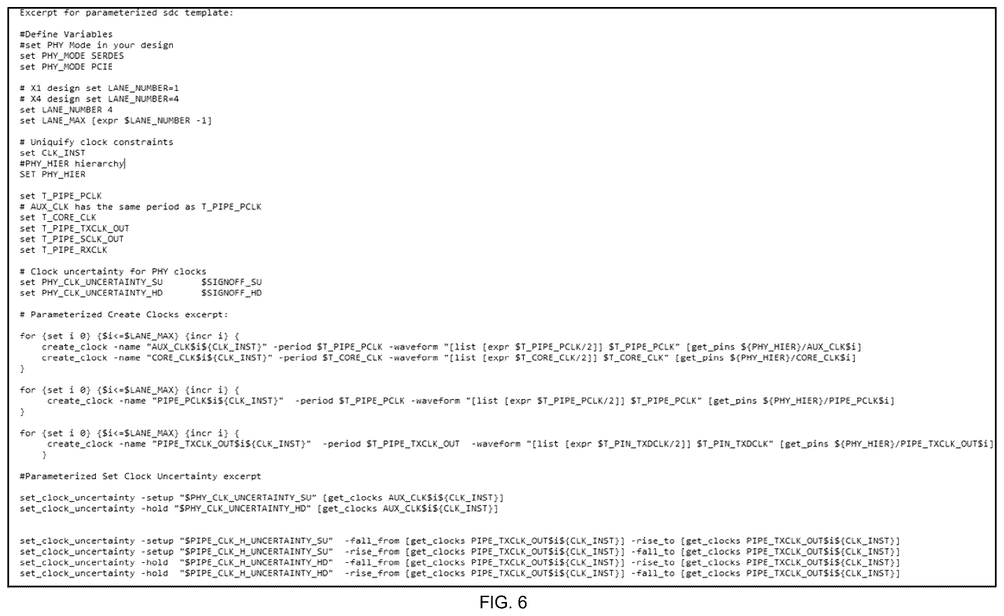

In some embodiments, the generative AI module 106 is configured to automatically generate a design constraint template for the specific chip interface IP using the one or more trained LLMs based on one or more of the plurality of inputs describing the chip interface IP. Here, the design constraint template includes a plurality of features/fields of the design constraints for the specific chip interface IP. In some embodiments, the LLM training module 104 is configured to train the one or more LLMs based on knowledge from various IP documentations so that the generative AI module 106 is able to create the design constraint template for the specific chip interface IP based on the correct frequencies, uncertainty, exceptions, and additional timing tests. For a non-limiting example, the automatically-generated design constraint template can be utilized in new employee training, chip IP and tape-out design reviews, and improvements to IP documentation as discussed above. FIG. 6 depicts an example of an automatically-generated design constraint template in SDC tel, which includes parameters and some of the parameterized timing constraints for a few clocks, with their create_clock and create_clock_uncertainty statements set to variables.

In the example of FIG. 1, the document egress module 108 is configured to generate a human language text documentation by converting the set of design constraints in a programming language, e.g., SDC tel, wherein human language text documentation includes attributes specific to the specified portion of a chip or a specified chip IP block such as the chip interface IP. Such documentation can be used for design review of the chip interface IP to verify accuracy of the set of design constraints, and therefore, to determine whether the plurality of inputs of documentation on the chip interface IP were accurate and sufficient to provide a complete set of design constraint for timing analysis, or any improvement to the inputs is necessary. In some embodiments, the document egress module 108 is configured to translate one or more comments in the set of design constraints into cohesive human language and to create sections for the chip interface IP for design review. In some embodiments, the document egress module 108 is configured to convert a plurality of timing or clock-related design constraints into timing or clock related descriptions. For example, the document egress module 108 is configured to translate design constraint create_clock to a description on clock usage and waveform. For another example, the document egress module 108 is configured to translate design constraint set_clock_uncertainty to a description on clock margin and waveform. For another example, the document egress module 108 is configured to translate design constraint set_clock_groups to a clock relationship statement. For another example, the document egress module 108 is configured to translate design constraints set_max_delay and set_data_check to a signal relationship statement. In some embodiments, the document egress module 108 is configured to translate design constraints on multi-cycle and/or false paths into signal relationship statements. In some embodiments, the document egress module 108 is configured to insert statements into an attribute section defined by comments in the human language text documentation.

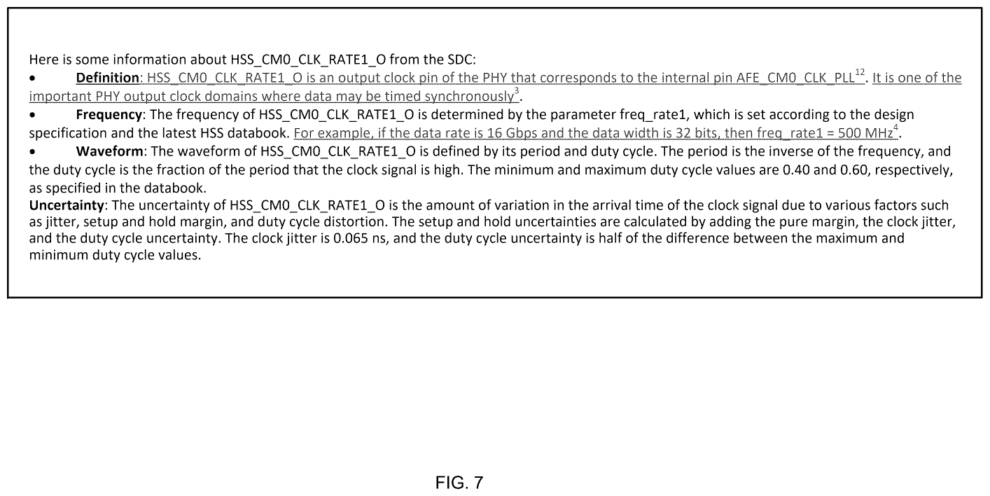

FIG. 7 depicts an example of a human language text documentation containing known information about a clock named HSS_CMO_CLK_RATE_1_O in an organized format generated by the document egress module 108 from a well commented thorough SDC. As shown by the example of FIG. 7, the human language text documentation includes definition, frequency, waveform, and uncertainty sections describing the clock HSS_CMO_CLK_RATE_1_O. This human language text documentation can be used for the design constraint accuracy review of design of the clock HSS_CMO_CLK_RATE_1_O.

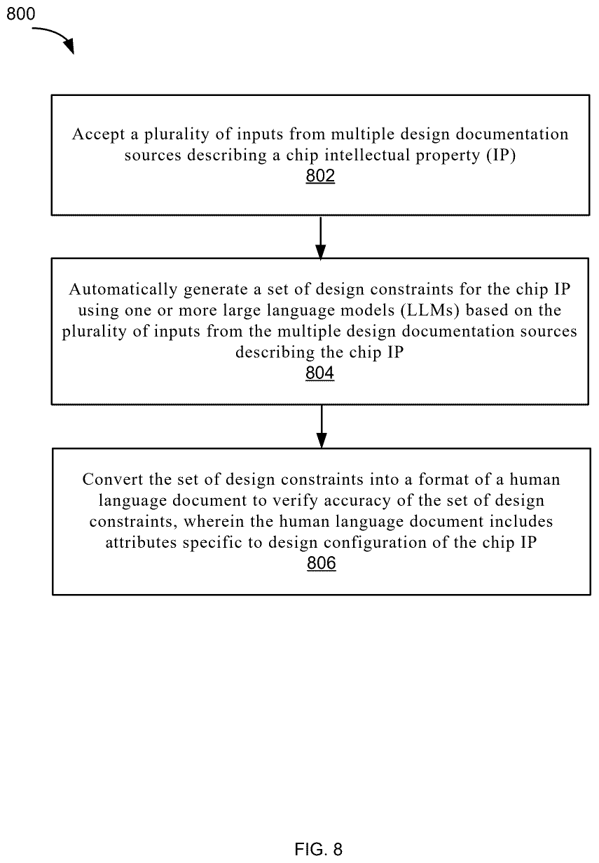

FIG. 8 depicts a flowchart 800 of an example of a process for automatic chip design constraint generation using generative AI. Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways.

In the example of FIG. 8, the flowchart 800 starts at block 802, where a plurality of inputs are accepted from multiple design documentation sources describing a chip intellectual property (IP). The flowchart 800 continues to step 804, where a set of design constraints are automatically generated for the chip IP using one or more large language models (LLMs) based on the plurality of inputs from the multiple design documentation sources describing the chip IP. The flowchart 800 ends at step 806, where the set of design constraints are converted into a format of a human language document to verify accuracy of the set of design constraints, wherein the human language document includes attributes specific to design configuration of the chip IP.

FIG. 9 is a block diagram illustrating an example of a computing system/device 900 used to implement the system 100 to support automatic chip design constraint generation using generative AI.

In the example of FIG. 9, the system 900 includes a processing unit 902, an interface bus 911, and an input/output (“IO”) unit 920. Processing unit 901 includes a processor 902, main memory 904, system bus 911, static memory device 906, bus control unit 905, and mass storage memory 908. Bus 911 is used to transmit information between various components and processor 902 for data processing. Processor 902 may be any of a wide variety of general-purpose processors, embedded processors, or microprocessors such as ARM® embedded processors, Intel® Core™2 Duo, Core™2 Quad, Xeon®, Pentium™ microprocessor, AMD® family processors, MIPS® embedded processors, RISC-V, or Power PC™ microprocessor.

Main memory 904, which may include multiple levels of cache memories, stores frequently used data and instructions. Main memory 904 may be RAM (random access memory), MRAM (magnetic RAM), or flash memory. Static memory 906 may be a ROM (read-only memory), which is coupled to bus 911, for storing static information and/or instructions. Bus control unit 905 is coupled to buses 911-912 and controls which component, such as main memory 904 or processor 902, can use the bus. Mass storage memory 908 may be a magnetic disk, solid-state drive (“SSD”), optical disk, hard disk drive, floppy disk, CD-ROM, and/or flash memories for storing large amounts of data.

I/O unit 920, in one example, includes a display 921, keyboard 922, cursor control device 923, decoder 924, and communication device 925. Display device 921 may be a liquid crystal device, flat panel monitor, cathode ray tube (“CRT”), touch-screen display, or other suitable display device. Display 921 projects or displays graphical images or windows. Keyboard 922 can be a conventional alphanumeric input device for communicating information between computer system 900 and computer operators. Another type of user input device is cursor control device 923, such as a mouse, touch mouse, trackball, or other type of cursor for communicating information between system 900 and users.

Communication device 925 is communicatively coupled to bus 912 for accessing information from remote computers or servers through wide-area network. Communication device 925 may include a modem, a router, or a network interface device, or other similar devices that facilitate communication between computer 900 and the network. In one aspect, communication device 925 is configured to perform wireless functions.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and the various modifications that are suited to the particular use contemplated.

What is claimed is:

1. An apparatus to support automatic design constraint generation, comprising:
a document ingress module configured to accept a plurality of inputs from multiple design documentation sources describing a chip intellectual property (IP);
a generative artificial intelligence (AI) module configured to automatically generate a set of design constraints for the chip IP using one or more large language models (LLMs) based on the plurality of inputs from the multiple design documentation sources describing the chip IP; and
a document egress module configured to convert the set of design constraints into a format of a human language document to verify accuracy of the set of design constraints, wherein the human language document includes attributes specific to design configuration of the chip IP.

2. The apparatus of claim 1, wherein:
the one or more LLMs are coded in Synopsis design constraint (SDC) Tcl.

3. The apparatus of claim 1, wherein:
the chip IP is a chip interface IP.

4. The apparatus of claim 1, wherein:
the set of design constraints are static timing constraints.

5. The apparatus of claim 1, wherein:
the plurality of inputs include one or more of a human language documentation describing the chip IP, a design constraint template of the chip IP, and design information of the chip IP.

6. The apparatus of claim 1, wherein:
the document ingress module is configured to verify consistencies among the plurality of inputs and to correct any inconsistencies or errors in the plurality of inputs regarding the chip IP.

7. The apparatus of claim 1, wherein:
the document ingress module is configured to consolidate and integrate the plurality of inputs into one unified documentation before providing such unified documentation to generate the set of design constraints.

8. The apparatus of claim 1, wherein:
the generative AI module is configured to generate a set of generic design constraints that is not specific to the chip IP using an untrained LLM.

9. The apparatus of claim 1, further comprising:
an LLM training module configured to train the one or more LLMs with a targeted training material on the chip IP.

10. The apparatus of claim 9, wherein:
type and/or content of the targeted training material utilized to train the one or more LLMs affects the set of design constraints to be generated or inferred from the one or more so-trained LLMs.

11. The apparatus of claim 9, wherein:
one of the trained LLMs is a retrieval augmented generative (RAG) system.

12. The apparatus of claim 1, wherein:
the generative AI module is configured to automatically generate a design constraint template specific to the set of design constraints of the chip IP.

13. The apparatus of claim 1, wherein:
the document egress module is configured to translate one or more comments in the set of design constraints into cohesive human language and to create sections for the chip IP for design review.

14. A method to support automatic design constraint generation, comprising:
accepting a plurality of inputs from multiple design documentation sources describing a chip intellectual property (IP);
automatically generating a set of design constraints for the chip IP using one or more large language models (LLMs) based on the plurality of inputs from the multiple design documentation sources describing the chip IP; and
converting the set of design constraints into a format of a human language document to verify accuracy of the set of design constraints, wherein the human language document includes attributes specific to design configuration of the chip IP.

15. The method of claim 14, further comprising:
verifying consistencies among the plurality of inputs and to correct any inconsistencies or errors in the plurality of inputs regarding the chip IP.

16. The method of claim 14, further comprising:
consolidating and integrating the plurality of inputs into one unified documentation before providing such unified documentation to generate the set of design constraints.

17. The method of claim 14, further comprising:
generating a set of generic design constraints that is not specific to the chip IP using an untrained LLM.

18. The method of claim 14, further comprising:
training the one or more LLMs with a targeted training material on the chip IP, wherein one of the trained LLMs is a retrieval augmented generative (RAG) system.

19. The method of claim 14, further comprising:
automatically generating a design constraint template specific to the set of design constraints of the chip IP.

20. A system to support automatic design constraint generation, comprising:
a means for accepting a plurality of inputs from multiple design documentation sources describing a chip intellectual property (IP);
a means for automatically generating a set of design constraints for the chip IP using one or more large language models (LLMs) based on the plurality of inputs from the multiple design documentation sources describing the chip IP; and
a means for converting the set of design constraints into a format of a human language document to verify accuracy of the set of design constraints, wherein the human language document includes attributes specific to design configuration of the chip IP.
